(19) United States
(12) Patent Application Publication
(10) Pub. No.: US 2024/0275183 A1
(43) Pub. Date: Aug. 15, 2024

(54) BATTERY PACK

(71) Applicant: HONDA MOTOR CO., LTD., Tokyo (JP)

(72) Inventors: Soichi MORII, Saitama (JP); Yasuo YAMADA, Saitama (JP); Yasushi OGIHARA, Saitama (JP); Harumi TAKEDOMI, Saitama (JP); Hideki SAKAMOTO, Saitama (JP)

(21) Appl. No.: 18/409,819

(22) Filed: Jan. 11, 2024

(30) Foreign Application Priority Data
Feb. 14, 2023 (JP) 2023-020479

(51) Int. Cl. H02J 7/00; H01M 50/204; H01M 50/249

(52) U.S. Cl. CPC H02J 7/0024; H01M 50/204; H01M 50/249; H01M 2220/20

(57) ABSTRACT

A battery pack 1 includes: a first module block 5 and a second module block 6 arranged side-by-side; and a connection switching circuit 7 including a series-connection switching element 8 and parallel-connection switching elements 9 and 10 configured to selectively switch connection between the first and second module blocks between a series connection and a parallel connection. In the connection switching circuit, the series-connection switching element is provided at a midpoint in the series connection and located at an inner side of an area where the module blocks are disposed in the battery pack in a top view of this area, and terminals of the modules in the first and second module blocks 5 and 6 are connected to the connection switching circuit and located close to the connection switching circuit, thereby capable of simplifying the layout of the switching circuit for changing the connection status of the module blocks.

This application is based on and claims the benefit of priority from Japanese Patent Application No. 2023-020479, filed on 14 Feb. 2023, the content of which is incorporated herein by reference.

### BACKGROUND OF THE INVENTION

### Field of the Invention

The present invention relates to a battery pack.

### Related Art

A battery pack that has been proposed switches the connection status of a plurality of module blocks between discharging and charging (see, for example, Japanese Unexamined Patent Application, Publication No. 2020-162224).

In this battery pack, each of the module blocks includes a plurality of modules connected in series. Each of the modules includes a plurality of cells electrically connected to one another.

According to Japanese Unexamined Patent Application, Publication No. 2020-162224, the connection status of the module blocks is changed when charging of the module blocks begins, and thus the battery pack achieves a reduction in heat generation in the module blocks during the charging. The battery pack also achieves optimization of the voltage of electric power that is supplied from the module blocks to a load during discharging.
Patent Document 1: Japanese Unexamined Patent Application, Publication No. 2020-162224

### SUMMARY OF THE INVENTION

The proposal in Japanese Unexamined Patent Application, Publication No. 2020-162224 does not present a viewpoint of making adaptations to charging voltages defined according to specifications of charging devices, a technical problem of simplifying the layout and reducing the size of a switching circuit for changing the connection status of the module blocks, or naturally a way to deal with this technical problem.

The present invention was made in view of the foregoing circumstances, and an object thereof is to provide a battery pack that includes a plurality of electrically-connected modules each including a plurality of electrically-connected cells, and that makes it possible to simplify the layout of a switching circuit for changing the connection status of module blocks, to reduce the size of the switching circuit, and to make adaptations to charging voltages defined according to specifications of charging devices.

(1) A battery pack (for example, a battery pack 1 described below) including: a first module block (for example, a first module block 5 described below) and a second module block (for example, a second module block 6 described below) arranged side-by-side, the first and second module blocks being separate module blocks each including a plurality of modules (for example, modules 3 described below) electrically connected to one another, the plurality of modules each including a plurality of cells (for example, cells 2 described below) electrically connected to one another; and a connection switching circuit (for example, a connection switcher 7 described below) including a series-connection switching element (for example, a series-connection contactor 8 described below) and a parallel-connection switching element (for example, a positive-electrode-connection contactor 9 and a negative-electrode-connection contactor 10 described below) configured to selectively switch connection between the first and second module blocks between a series connection and a parallel connection, wherein in the connection switching circuit, the series-connection switching element is provided at a midpoint in the series connection and located at an inner side of an area where the module blocks are disposed in the battery pack in a top view of this area, and terminals (for example, a positive terminal 231, a negative terminal 262, a positive terminal 271, and a negative terminal 302 described below) of the modules in the first and second module blocks are connected to the connection switching circuit and located close to the connection switching circuit.

(2) The battery pack described in (1), wherein the first and second module blocks include a switching-side module group (for example, a switching-side module group 31 described below), which is a group of modules each having a terminal serving as a switching terminal (for example, a switching terminal 32 described below) connected to the connection switching circuit among the plurality of modules, and a total-power-output-side module group (for example, a total-power-output-side module group 33 described below), which is a group of modules each having a terminal serving as a total-power-output terminal (for example, a total-power-output terminal 170 described below) to which a total power outputted from the first and second module blocks is directed among the plurality of modules, the switching terminals are located in respective module end sections closer to the total-power-output-side module group in the modules belonging to the switching-side module group, and the total-power-output terminals are located in respective module end sections closer to the switching-side module group in the modules belonging to the total-power-output-side module group.

(3) The battery pack described in (2), wherein the total-power-output terminals are electrically connected to a junction board (for example, a junction board 34 described below) for the battery pack, and the total-power-output terminals in the first and second module blocks are respectively provided in module end sections at neighboring sides of the mutually neighboring modules belonging to the total-power-output-side module group.

(4) The battery pack described in (2), wherein the connection switching circuit includes, as the series-connection switching element, a series-connection contactor (for example, a series-connection contactor 8 described below) configured to connect the first module block and the second module block in series when the series-connection contactor is on, the switching terminals are respectively provided in module end sections at neighboring sides of the mutually neighboring modules belonging to the switching-side module group, the series-connection contactor is disposed between the switching terminal in the first module block and the switching terminal in the second module block, and the series-connection contactor is electrically connected to each of the switching terminals.

(5) The battery pack described in (2), including, as the parallel-connection switching element, a plurality of parallel-connection contactors (for example, a positive-electrode-connection contactor 9 and a negative-electrode-connection contactor 10 described below) disposed between the switching terminals and the total-power-output terminals, and electrically connected to the total-power-output terminals and the switching terminals.

(6) The battery pack described in (1), wherein the series-connection switching element, a conductor (for example, a bus bar 11a described below) connecting the series-connection switching element and the first module block, and a conductor (for example, a bus bar 11b described below) connecting the series-connection switching element and the second module block are configured as a single module (for example, a contactor module 71 described below).

(7) The battery pack described in (1), including two parallel-connection switching elements as the parallel-connection switching element, wherein the series-connection switching element, the two parallel-connection switching elements, a conductor (for example, a bus bar 11a described below) connecting the series-connection switching element and the first module block, a conductor (for example, a bus bar 11b described below) connecting the series-connection switching element and the second module block, a conductor (for example, a bus bar 12a described below) connecting one of the parallel-connection switching elements and the first module block, and a conductor (for example, a bus bar 13a described below) connecting the other parallel-connection switching element and the second module block are configured as a single module (for example, a contactor module 72 described below).

(8) The battery pack described in (1), including two parallel-connection switching elements as the parallel-connection switching element, wherein the series-connection switching element, the two parallel-connection switching elements, a conductor (for example, a bus bar 11a described below) connecting the series-connection switching element and the first module block, a conductor (for example, a bus bar 11b described below) connecting the series-connection switching element and the second module block, a conductor (for example, a bus bar 12a described below) connecting one of the parallel-connection switching elements and the first module block, a conductor (for example, a bus bar 13a described below) connecting the other parallel-connection switching element and the second module block, and a junction board (for example, a junction board 34 described below) located on adjacent portions of the first and second module blocks are configured as a single contactor-bus bar module (for example, a contactor-bus bar module 73 described below).

In the battery pack described in (1), the series-connection switching element, which is a circuit element of the connection switching circuit, is provided at a midpoint in the series connection between the first and second module blocks, and located at an inner side of an area where the module blocks are disposed in the battery pack in a top view of this area. Furthermore, the terminals of the modules in the first and second module blocks are connected to the connection switching circuit and located close to the connection switching circuit.

Because of this configuration, conductors and the switching elements, which switch the first and second module blocks between a series connection and a parallel connection, are concentrated and compactly arranged at the inner side of the area where the module blocks are disposed in the battery pack in a top view of this area, allowing for a reduction in circuit size of the battery pack as a whole.

The configuration of the battery pack described in (2) allows the switching elements that are necessary for the connection switching circuit to be gathered in close proximity to one another, allowing for a reduction in size of the switching circuit.

This configuration also allows for a reduction in circuit size of the battery pack including the connection switching circuit as a whole, because the connection switching circuit and the total-power-output terminals are in close proximity to one another.

A smaller circuit size allows for greater flexibility in the layout of the battery pack and an area around the battery pack.

The above-described configuration also allows the circuit configuration to be less complex, achieving a reduction in length of conductors such as bus bars and simplified routing thereof.

The configuration of the battery pack described in (3) allows for compact connection of the conductors to the junction board compared to a configuration in which the total-power-output terminals are distant from each other.

The configuration of the battery pack described in (4) allows for a reduction in length of conductors that connect the switching terminals and the series-connection contactor, because the switching terminal in the first module block, the switching terminal in the second module block, and the series-connection contactor are in close proximity to one another.

The configuration of the battery pack described in (5) allows for a reduction in length of conductors that connect the parallel-connection contactors, the total-power-output terminals, and the switching terminals, because the parallel-connection contactors, the total-power-output terminals, and the switching terminals are in close proximity to one another.

The configuration of the battery pack described in (6) makes it easy to concentrate and compactly arrange the conductors and the switching elements, which switch the first and second module blocks between a series connection and a parallel connection, at an inner side of an area where the module blocks are disposed in the battery pack in a top view of this area, because some of the circuit elements in and around the connection switching circuit are configured as a module. For the same reason, this configuration makes it easier to manufacture the battery pack.

The configuration of the battery pack described in (7) makes it easy to concentrate and compactly arrange the conductors and the switching elements, which switch the first and second module blocks between a series connection and a parallel connection, at an inner side of an area where the module blocks are disposed in the battery pack in a top view of this area, because the circuit elements in and around the connection switching circuit including all the switching elements of the connection switching circuit are configured as a module. For the same reason, this configuration makes it much easier to manufacture the battery pack.

The configuration of the battery pack described in (8) makes it easy to concentrate and compactly arrange the conductors and the switching elements, which switch the first and second module blocks between a series connection and a parallel connection, at an inner side of an area where the module blocks are disposed in the battery pack in a top view of this area, because the junction board and the circuit elements in and around the connection switching circuit including all the switching elements of the connection switching circuit are configured as a module. For the same reason, this configuration makes it even easier to manufacture the battery pack.

### BRIEF DESCRIPTION OF THE DRAWINGS

FIG. 1 is a circuit diagram showing module blocks connected in series in a battery pack according to the present disclosure;

FIG. 2 is a circuit diagram showing the module blocks connected in parallel in the battery pack according to the present disclosure;

FIG. 3 is a diagram showing an example of a layout of circuit elements in the battery pack according to the present disclosure;

FIG. 4 is a diagram showing details of the layout of the circuit elements in and around a connection switcher in the battery pack according to the present disclosure;

FIG. 5 is a diagram showing another example of the layout of the circuit elements in the battery pack according to the present disclosure;

FIG. 6 is a diagram showing another example of the layout of the circuit elements in the battery pack according to the present disclosure;

FIG. 7 is a diagram showing another example of the layout of the circuit elements in the battery pack according to the present disclosure;

FIG. 8 is a diagram showing a modification example of the layout of the circuit elements in the battery pack according to the present disclosure;

FIG. 9 is a diagram showing another modification example of the layout of the circuit elements in the battery pack according to the present disclosure; and

FIG. 10 is a diagram showing another modification example of the layout of the circuit elements in the battery pack according to the present disclosure.

### DETAILED DESCRIPTION OF THE INVENTION

The following describes an embodiment of the present invention with reference to the accompanying drawings.

In the drawings mentioned below, the same or corresponding elements are labeled with the same reference numerals.

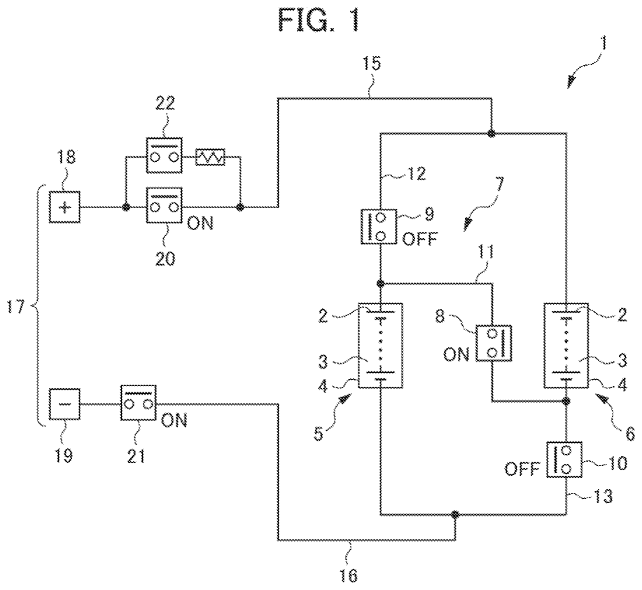

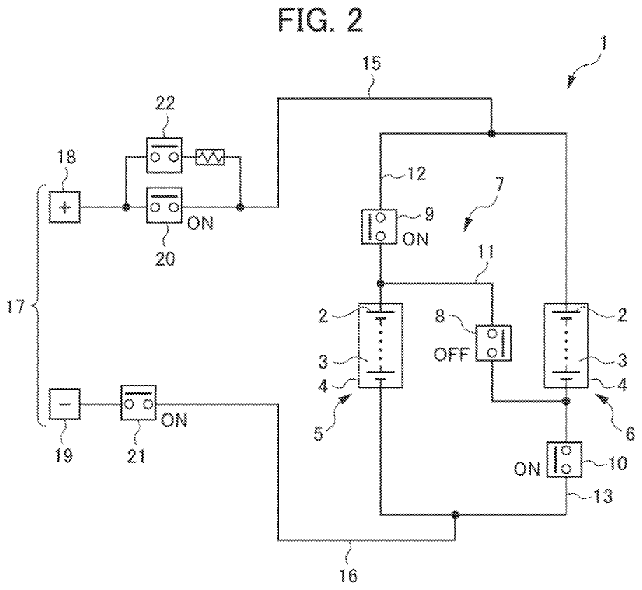

FIGS. 1 and 2 are each a circuit diagram related to a battery pack 1 according to the present disclosure.

In FIGS. 1 and 2, the battery pack 1 includes a plurality of module blocks 4. Each of the module blocks 4 includes a plurality of modules 3 electrically connected to one another, and each of the modules 3 includes a plurality of cells 2 electrically connected to one another.

In examples shown in FIGS. 1 and 2, the battery pack 1 includes two module blocks 4, which are separate module blocks referred to as a first module block 5 and a second module block 6.

FIG. 1 shows the first module block 5 and the second module block 6 connected in series, and FIG. 2 shows the first module block 5 and the second module block 6 connected in parallel.

In FIGS. 1 and 2, the battery pack 1 includes a connection switcher 7, which is a connection switching circuit that switches the electrical connection status of the first module block 5 and the second module block 6 between series and parallel.

The connection switcher 7 includes a series-connection contactor 8 as a series-connection switching element, a positive-electrode-connection contactor 9 as one of two parallel-connection switching elements, and a negative-electrode-connection contactor 10 as the other parallel-connection switching element.

The series-connection contactor 8 is interposed between portions of a conductor 11 that connects a positive electrode of the first module block 5 and a negative electrode of the second module block 6, and connects the first module block 5 and the second module block 6 in series when the series-connection contactor 8 is on.

As shown in FIG. 1, the series-connection contactor 8 is turned on, and the positive-electrode-connection contactor 9 and the negative-electrode-connection contactor 10 are turned off to form a series connection of the first module block 5 and the second module block 6.

The positive-electrode-connection contactor 9 is interposed between portions of a conductor 12 that connects the positive electrode of the first module block 5 and a positive electrode of the second module block 6.

The negative-electrode-connection contactor 10 is interposed between portions of a conductor 13 that connects a negative electrode of the first module block 5 and the negative electrode of the second module block 6.

As shown in FIG. 2, the positive-electrode-connection contactor 9 and the negative-electrode-connection contactor 10 are turned on, and the series-connection contactor 8 is turned off to form a parallel connection of the first module block 5 and the second module block 6.

When the series connection of the first module block 5 and the second module block 6 is formed by the connection switcher 7, the battery pack 1 can be charged using a charging device designed for high voltage that supplies a charging voltage twice the rated charging voltage of a single module block.

When the parallel connection of the first module block 5 and the second module block 6 is formed by the connection switcher 7, the battery pack 1 can be charged using a charging device designed for lower voltage that supplies a charging voltage comparable to the rated charging voltage of a single module block.

That is, the battery pack 1 allows for selective adaptations to charging devices that differ in charging voltage defined according to the specifications, by switching the first module block 5 and the second module block 6 between the series connection and the parallel connection using the connection switcher 7.

The power output of the series connection of the first module block 5 and the second module block 6 in FIG. 1, and the power output of the parallel connection of the first module block 5 and the second module block 6 in FIG. 2 are each the total power from the connection of the first module block 5 and the second module block 6.

This total power is outputted between a positive-electrode output conductor 15 and a negative-electrode output conductor 16, and is directed to total-power-output external terminals 17, which are external connection terminals.

The total-power-output external terminals 17 include a positive-electrode total-power-output external terminal 18 on the positive-electrode output conductor 15 side and a negative-electrode total-power-output external terminal 19 on the negative-electrode output conductor 16 side.

The total power output of each connection of the first module block 5 and the second module block 6 occurs between the positive-electrode output conductor 15 and the negative-electrode output conductor 16.

That is, the total power output occurs between the positive electrode of the second module block 6 and the negative electrode of the first module block 5.

From this viewpoint, as described below, a positive terminal 231 of a first module 23 in the second module block 6 is a total-power-output positive terminal, and a negative terminal 302 of an eighth module 30 in the first module block 5 is a total-power-output negative terminal.

A positive-electrode output contactor 20 is interposed between the positive-electrode total-power-output external terminal 18 of the positive-electrode output conductor 15 and the conductor 12 described above.

A negative-electrode output contactor 21 is interposed between the negative-electrode total-power-output external terminal 19 of the negative-electrode output conductor 16 and the conductor 13 described above.

A pre-charge contactor 22 having a pre-charge resistor for mitigating inrush current is provided beside the positive-electrode output contactor 20.

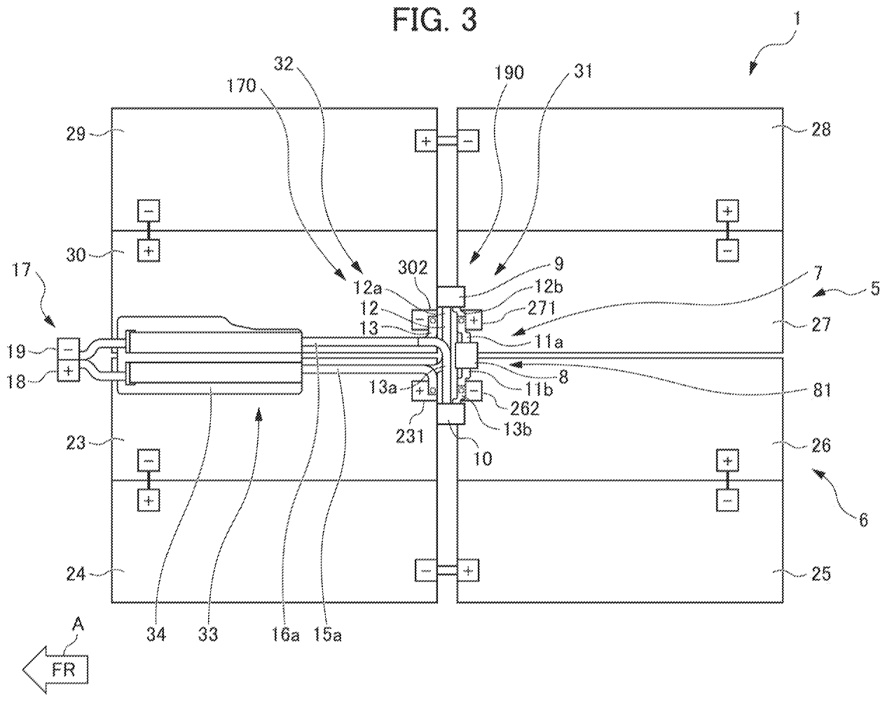

FIG. 3 is a diagram showing an example of a layout of circuit elements in the battery pack 1 according to the present disclosure.

The battery pack 1 shown in FIG. 3 is designed for installation in a vehicle, not shown, and each of the modules 3 forming the first module block 5 and the second module block 6 is arranged so that the longitudinal direction thereof in a plan view is along a front-back direction indicated by an arrow A in the vehicle.

The battery pack 1 shown in FIG. 3 has the connection switcher 7 and the total-power-output external terminals 17 for the first module block 5 located on the upper side in FIG. 3 (right side in the aforementioned vehicle) and the second module block 6 located on the lower side in FIG. 3 (left side in the aforementioned vehicle).

The first module block 5 includes four modules connected in series: a fifth module 27, a sixth module 28, a seventh module 29, and the eighth module 30.

As shown in FIG. 3, the fifth module 27, the sixth module 28, the seventh module 29, and the eighth module 30 are all rectangular and similar in shape in a plan view, and each module has a pair of positive and negative module terminals provided in end sections distant from each other along a diagonal of the module.

The second module block 6 includes four modules connected in series: the first module 23, a second module 24, a third module 25, and a fourth module 26.

As shown in FIG. 3, the first module 23, the second module 24, the third module 25, and the fourth module 26 are all rectangular and similar in shape in a plan view, and each module has a pair of positive and negative module terminals provided in end sections distant from each other along a diagonal of the module.

As described above with reference to FIGS. 1 and 2, the connection switcher 7 includes the series-connection contactor 8, the positive-electrode-connection contactor 9, and the negative-electrode-connection contactor 10.

A site on the electrical circuit where the series-connection contactor 8 is located is a point where the two circuit elements are connected, and may be referred to as a “midpoint”.

In the present disclosure, a portion of the circuit where the first module block 5 and the second module block 6 are connected in series by connecting terminals of different polarities of the two module blocks 5 and 6 is referred to as the midpoint.

In the circuit shown in FIGS. 1 and 2, the series-connection contactor 8 at this site is electrically turned on or off, so that the first module block 5 and the second module block 6 are switched between a series-connected state and a parallel-connected state.

The positive-electrode-connection contactor 9 and the negative-electrode-connection contactor 10 are also electrically turned on or off, so that the first module block 5 and the second module block 6 are switched between the series-connected state and the parallel-connected state.

In the present disclosure, in view of the foregoing, a portion of the circuit including the connection switcher 7 that connects the first module block 5 and the second module block 6 in a manner such that these module blocks are switchable between the series-connected state and the parallel-connected state is referred to as a connection switching circuit 81.

Referring to FIGS. 1 to 3, the following describes connection between the positive-electrode-connection contactor 9, the negative-electrode-connection contactor 10, and specific modules.

The positive terminal 231 of the first module 23 is connected to one terminal of the positive-electrode-connection contactor 9, and a positive terminal 271 of the fifth module 27 is connected to the other terminal of the positive-electrode-connection contactor 9.

A negative terminal 262 of the fourth module 26 is connected to one terminal of the negative-electrode-connection contactor 10, and the negative terminal 302 of the eighth module 30 is connected to the other terminal of the negative-electrode-connection contactor 10.

One terminal of each of the fourth and fifth modules 26 and 27 is connected to the series-connection contactor 8 of the connection switcher 7 in the connection switching circuit 81.

From this viewpoint, the fourth module 26 and the fifth module 27 are collectively referred to as a switching-side module group 31.

The negative terminal 262 of the fourth module 26 and the positive terminal 271 of the fifth module 27 are connected to the series-connection contactor 8 of the connection switcher 7 in the connection switching circuit 81.

From this viewpoint, the negative terminal 262 of the fourth module 26 and the positive terminal 271 of the fifth module 27 are collectively referred to as switching terminals 32.

The positive terminal 231 of the first module 23 is connected to the positive-electrode total-power-output external terminal 18 of the total-power-output external terminals 17, and the negative terminal 302 of the eighth module 30 is connected to the negative-electrode total-power-output external terminal 19 of the total-power-output external terminals 17.

As described above, the positive terminal 231 of the first module 23 in the second module block 6 is the total-power-output positive terminal, and the negative terminal 302 of the eighth module 30 in the first module block 5 is the total-power-output negative terminal.

Accordingly, the positive terminal 231, which is the total-power-output positive terminal, and the negative terminal 302, which is the total-power-output negative terminal, are collectively referred to as total-power-output terminals 170.

That is, among the modules in the first module block 5 and the second module block 6, one terminal of the first module 23 and one terminal of the eighth module 30 serve as the total-power-output terminals 170.

From this viewpoint, the first module 23 and the eighth module 30 are collectively referred to as a total-power-output-side module group 33.

The positive-electrode output conductor 15 and the negative-electrode output conductor 16 in FIGS. 1 and 2 are composed of a bus bar 15a and a bus bar 16a in FIG. 3, respectively.

The bus bar 15a and the bus bar 16a are configured as conductors on a junction board 34. A significant portion of the junction board 34 is located on adjacent portions of the first module 23 and the eighth module 30.

The positive-electrode total-power-output external terminal 18 is provided at a site where the bus bar 15a is connected to an external circuit, and the negative-electrode total-power-output external terminal 19 is provided at a site where the bus bar 16a is connected to the external circuit.

The positive-electrode output contactor 20 and the negative-electrode output contactor 21 are provided on the junction board 34 in the connections shown in FIGS. 1 and 2.

This configuration prevents the total power of the battery pack 1 from being accidentally directed to the positive-electrode total-power-output external terminal 18 and the negative-electrode total-power-output external terminal 19, being compatible with standard handling during manufacture and maintenance.

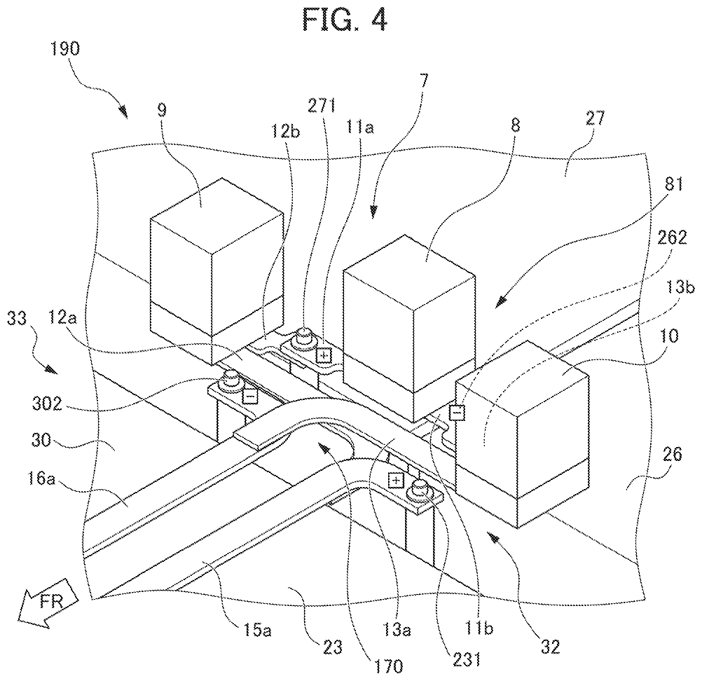

FIG. 4 is a diagram showing details of the layout of the circuit elements in and around the connection switcher 7 in the battery pack 1 according to the present disclosure.

The bus bar 15a is routed from the positive terminal 231 of the first module 23, and linearly extends along the adjacent portions of the first module 23 and the eighth module 30 toward the positive-electrode total-power-output external terminal 18 described above.

The bus bar 16a is routed from the negative terminal 302 of the eighth module 30, and linearly extends in parallel with the bus bar 15a along the adjacent portions of the first module 23 and the eighth module 30 toward the negative-electrode total-power-output external terminal 19 described above.

The positive terminal 231 and the negative terminal 302 are the total-power-output terminals 170.

The series-connection contactor 8, the positive-electrode-connection contactor 9, and the negative-electrode-connection contactor 10 forming the connection switcher 7 are located toward mutually adjacent portions of the first module 23 and the eighth module 30 belonging to the total-power-output-side module group 33, and toward mutually adjacent portions of the fourth module 26 and the fifth module 27 belonging to the switching-side module group 31.

In this arrangement, the series-connection contactor 8, which is a series-connection switching element, is located at an inner side of an area where the module blocks (first and second module blocks 5 and 6) are disposed in the battery pack 1 in a top view of this area.

One terminal of the series-connection contactor 8 is connected to the positive terminal 271 of the fifth module 27 by one bus bar 11a forming the conductor 11.

The other terminal of the series-connection contactor 8 is connected to the negative terminal 262 of the fourth module 26 by another bus bar 11b forming the conductor 11.

The negative terminal 262 is not visible from the viewpoint of FIG. 4, but is labeled using a dashed lead line for convenience.

One terminal of the positive-electrode-connection contactor 9 is connected to the bus bar 15a via a bus bar 12a forming the conductor 12, and is thus connected to the positive terminal 231 of the first module 23.

The other terminal of the positive-electrode-connection contactor 9 is connected to the positive terminal 271 of the fifth module 27 by another bus bar 12b forming the conductor 12.

One terminal of the negative-electrode-connection contactor 10 is connected to the negative terminal 262 of the fourth module 26 by one bus bar 13b (not visible in FIG. 4) forming the conductor 13.

The other terminal of the negative-electrode-connection contactor 10 is connected to the bus bar 16a via a bus bar 13a forming the conductor 13, and is thus connected to the negative terminal 302 of the eighth module 30.

In other words, the positive-electrode-connection contactor 9 is disposed between the positive terminal 271, which is one of the switching terminals 32, and the positive terminal 231, which is one of the total-power-output terminals 170, and is electrically connected to the positive terminal 231 and the positive terminal 271.

The negative-electrode-connection contactor 10 is connected to the negative terminal 262, which is the other switching terminal 32, and the negative terminal 302, which is the other total-power-output terminal 170.

As such, the positive-electrode-connection contactor 9 and the negative-electrode-connection contactor 10 are a plurality of parallel-connection contactors 190 that are disposed between the switching terminals 32 and the total-power-output terminals 170, and that are electrically connected to the total-power-output terminals 170 and the switching terminals 32.

Of the positive terminal 231, the negative terminal 262, the positive terminal 271, and the negative terminal 302 described above, the negative terminal 262 and the positive terminal 271, which are the switching terminals 32, of the fourth module 26 and the fifth module 27, which fall under the switching-side module group 31, are provided in module end sections closer to the first module 23 and the eighth module 30, which fall under the total-power-output-side module group 33.

By contrast, of the terminals of the modules that fall under the total-power-output-side module group 33, the total-power-output terminals 170, which include the positive terminal 231 of the first module 23 and the negative terminal 302 of the eighth module 30, are provided in module end sections closer to the fourth module 26 and the fifth module 27, which fall under the switching-side module group 31.

In the battery pack 1 according to the present disclosure having the configuration described above, the series-connection contactor 8, the positive-electrode-connection contactor 9, and the negative-electrode-connection contactor 10 forming the connection switcher 7 can be gathered and arranged in close proximity to one another.

This configuration allows for a reduction in size of the connection switcher 7.

This configuration also allows for a reduction in distance between the positions of the positive-electrode-connection contactor 9 and the negative-electrode-connection contactor 10, which are elements forming the connection switcher 7, and the positive terminal 231 and the negative terminal 302, which are the total-power-output terminals 170.

The above-described configuration therefore allows for a reduction in circuit size of the battery pack 1 including the connection switcher 7 as a whole.

A smaller circuit size allows for greater flexibility in the layout of the battery pack 1 and an area around the battery pack 1 in an object in which the battery pack 1 is mounted.

Furthermore, the above-described configuration allows the circuit configuration in and around the connection switcher 7 to be less complex, achieving a reduction in length of conductors such as bus bars and simplified routing thereof. Consequently, the productivity is improved, and thus sufficient product reliability is ensured.

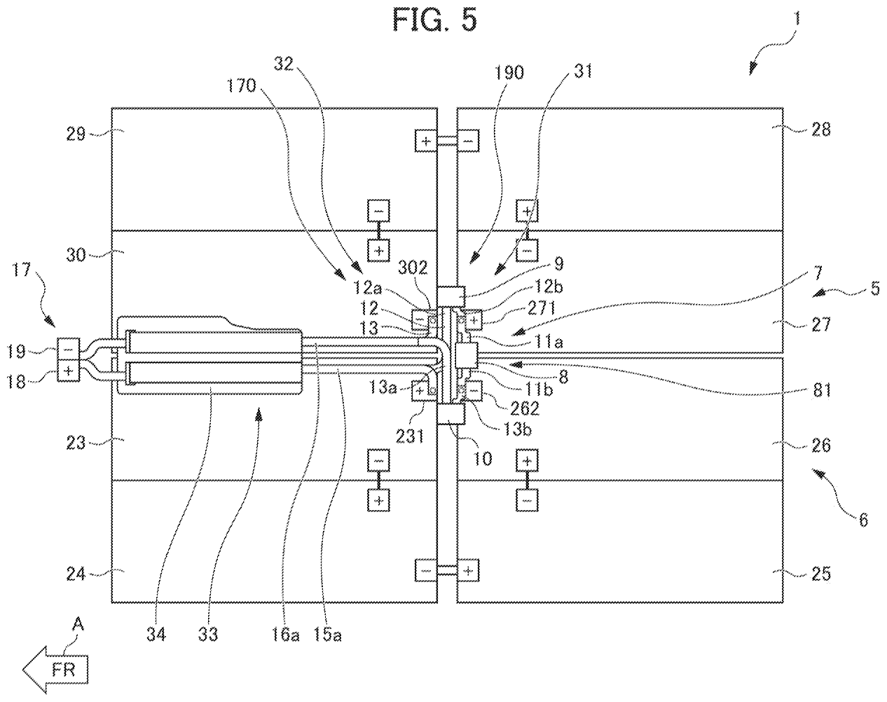

FIG. 5 is a diagram showing another example of the layout of the circuit elements in the battery pack 1 described with reference to FIGS. 1 to 4.

The example shown in FIG. 5 is equivalent to that in FIG. 3 in terms of electrical circuitry. Therefore, elements corresponding to those in FIG. 3 are labeled with the same reference numerals, and description thereof is omitted by utilizing the description given above with reference to FIGS. 1 to 4.

The example shown in FIG. 5 is different from that in FIG. 3 in arrangement of module terminals in each module.

The first module block 5 in the example shown in FIG. 5 includes four modules connected in series: the fifth module 27, the sixth module 28, the seventh module 29, and the eighth module 30. As shown in FIG. 5, the fifth module 27, the sixth module 28, the seventh module 29, and the eighth module 30, which are rectangular in a plan view, each have positive and negative module terminals provided in a module end section close to one short side of the module.

The second module block 6 includes four modules connected in series: the first module 23, the second module 24, the third module 25, and the fourth module 26. As shown in FIG. 5, the first module 23, the second module 24, the third module 25, and the fourth module 26, which are rectangular in a plan view, each have positive and negative module terminals provided in a module end section close to one short side of the module.

The example shown in FIG. 5 has the same advantageous effects as the example shown in FIGS. 1 to 4.

That is, the present invention produces the advantageous effects of the battery pack 1 including the modules in which the module terminals are arranged as shown in FIG. 3, even if the module terminals are arranged as shown in FIG. 5.

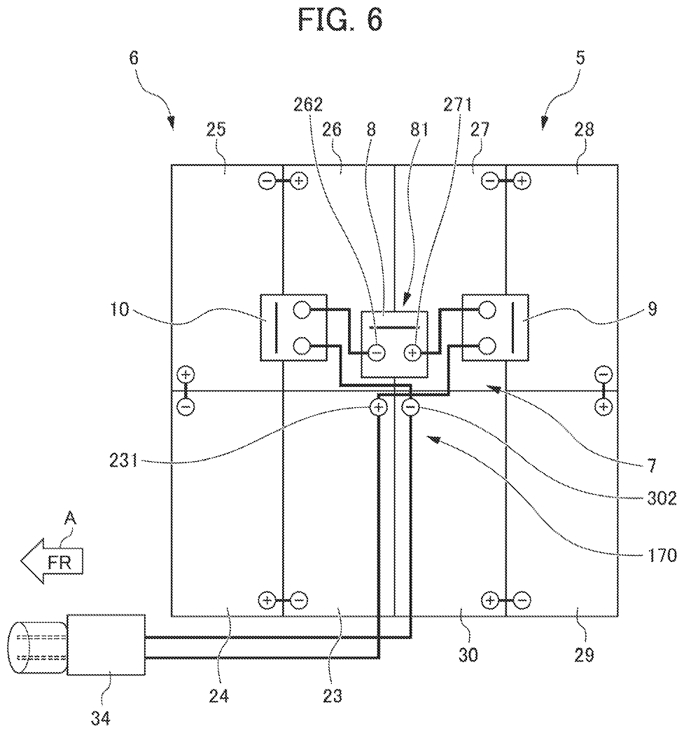

FIG. 6 is a diagram showing another example of the layout of the circuit elements in the battery pack 1 described with reference to FIGS. 1 to 4.

The example shown in FIG. 6 is equivalent to that in FIG. 3 in terms of electrical circuitry. Therefore, elements corresponding to those in FIG. 3 are labeled with the same reference numerals, and description thereof is omitted by utilizing the description given above with reference to FIGS. 1 to 4.

The example shown in FIG. 6 is different from that in FIG. 3 in the form of each module.

Specifically, the example shown in FIG. 6 is different from that in FIG. 3 in that the longitudinal direction of each module is along a direction orthogonal to the front-back direction of the vehicle in a plan view.

FIG. 6 shows terminals and contacts of the series-connection contactor 8, the positive-electrode-connection contactor 9, and the negative-electrode-connection contactor 10 forming the connection switcher 7.

The first module block 5 in the example shown in FIG. 6 includes four modules connected in series: the fifth module 27, the sixth module 28, the seventh module 29, and the eighth module 30.

As shown in FIG. 6, the fifth module 27, the sixth module 28, the seventh module 29, and the eighth module 30, which are rectangular in a plan view, each have positive and negative module terminals provided in module end sections distant from each other along a diagonal of the module.

The second module block 6 in the example shown in FIG. 6 includes four modules connected in series: the first module 23, the second module 24, the third module 25, and the fourth module 26.

As shown in FIG. 6, the first module 23, the second module 24, the third module 25, and the fourth module 26, which are rectangular in a plan view, each have positive and negative module terminals provided in module end sections distant from each other along a diagonal of the module.

The example shown in FIG. 6 has the same advantageous effects as the example shown in FIGS. 1 to 4.

That is, the present invention produces the advantageous effects of the battery pack 1 described with reference to FIGS. 1 to 4 even if the modules of the battery pack 1 are in the form shown in FIG. 6.

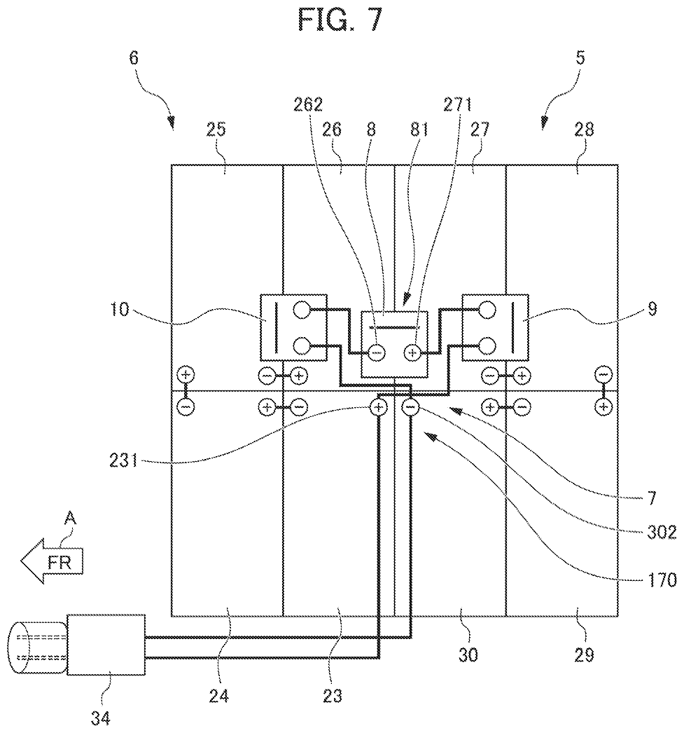

FIG. 7 is a diagram showing another example of the layout of the circuit elements in the battery pack 1 described with reference to FIGS. 1 to 4.

The example shown in FIG. 7 is equivalent to that in FIG. 3 in terms of electrical circuitry. Therefore, elements corresponding to those in FIG. 3 are labeled with the same reference numerals, and description thereof is omitted by utilizing the description given above with reference to FIGS. 1 to 4.

The example shown in FIG. 7 is different from that in FIG. 3 in the form of each module.

Specifically, the example shown in FIG. 7 is different from that in FIG. 3 in that the longitudinal direction of each module is along a direction orthogonal to the front-back direction of the vehicle in a plan view.

FIG. 7 shows terminals and contacts of the series-connection contactor 8, the positive-electrode-connection contactor 9, and the negative-electrode-connection contactor 10 forming the connection switcher 7.

The first module block 5 in the example shown in FIG. 7 includes four modules connected in series: the fifth module 27, the sixth module 28, the seventh module 29, and the eighth module 30.

As shown in FIG. 7, the fifth module 27, the sixth module 28, the seventh module 29, and the eighth module 30, which are rectangular in a plan view, each have positive and negative module terminals provided in a module end section close to one short side of the module.

The second module block 6 in the example shown in FIG. 7 includes four modules connected in series: the first module 23, the second module 24, the third module 25, and the fourth module 26.

As shown in FIG. 7, the first module 23, the second module 24, the third module 25, and the fourth module 26, which are rectangular in a plan view, each have positive and negative module terminals provided in a module end section close to one short side of the module.

The example shown in FIG. 7 has the same advantageous effects as the example shown in FIGS. 1 to 4.

That is, the present invention produces the advantageous effects of the battery pack 1 described with reference to FIGS. 1 to 4 even if the modules of the battery pack 1 are in the form shown in FIG. 7.

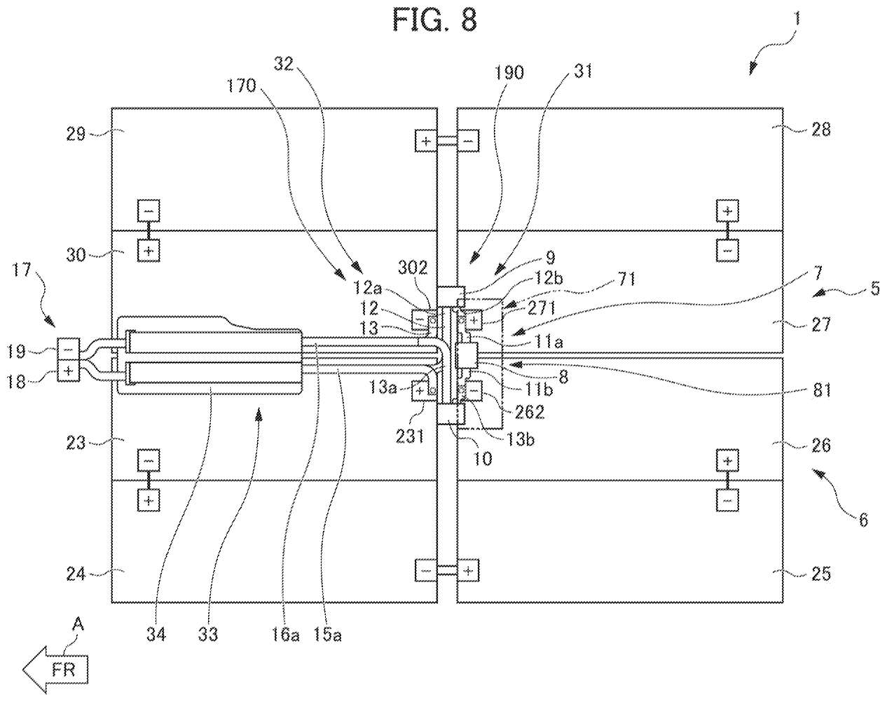

FIG. 8 is a diagram showing a modification example of the layout of the circuit elements in the battery pack 1 described with reference to FIGS. 1 to 4.

The example shown in FIG. 8 is equivalent to that in FIG. 3 in terms of electrical circuitry. Therefore, elements corresponding to those in FIG. 3 are labeled with the same reference numerals, and description thereof is omitted by utilizing the description given above with reference to FIGS. 1 to 4.

In the example shown in FIG. 8, the series-connection contactor 8 forming the connection switcher 7, and the bus bar 11a and the bus bar 11b are configured as a single contactor module 71.

The configuration of the example shown in FIG. 8 produces the advantageous effects in the example described with reference to FIGS. 1 to 4. Additionally, this configuration makes it easy to concentrate and compactly arrange the series-connection contactor 8 and the bus bars 11a and 11b, among the circuit elements in and around the connection switcher 7, at an inner side of an area where the module blocks (first and second module blocks 5 and 6) are disposed in the battery pack 1 in a top view of this area. This example also makes it much easier to manufacture the battery pack 1.

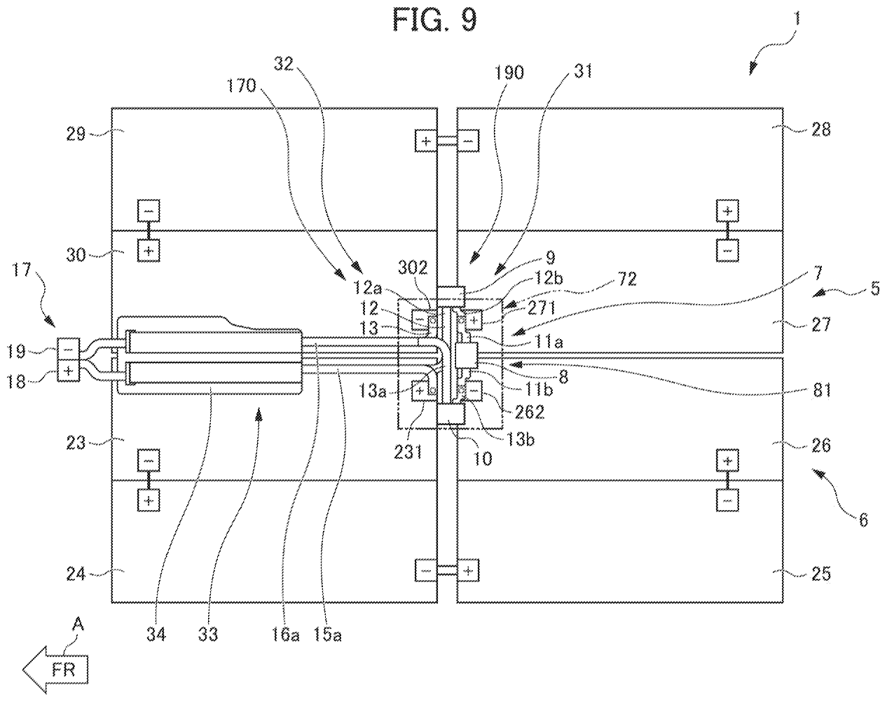

FIG. 9 is a diagram showing another modification example of the layout of the circuit elements in the battery pack 1 described with reference to FIGS. 1 to 4.

The example shown in FIG. 9 is equivalent to that in FIG. 3 in terms of electrical circuitry. Therefore, elements corresponding to those in FIG. 3 are labeled with the same reference numerals, and description thereof is omitted by utilizing the description given above with reference to FIGS. 1 to 4.

In the example shown in FIG. 9, the series-connection contactor 8, the positive-electrode-connection contactor 9, the negative-electrode-connection contactor 10 forming the connection switcher 7, and the bus bar 11a, the bus bar 11b, the bus bar 12a, and the bus bar 13a are configured as a single contactor module 72.

The configuration of the example shown in FIG. 9 produces the advantageous effects in the example described with reference to FIGS. 1 to 4. Additionally, this configuration makes it easy to concentrate and compactly arrange the conductors and the switching elements, which switch the first and second module blocks between a series connection and a parallel connection, at an inner side of an area where the module blocks (first and second module blocks 5 and 6) are disposed in the battery pack 1 in a top view of this area, because the circuit elements in and around the connection switcher 7 including all the switching elements of the connection switching circuit, i.e., the series-connection contactor 8, the positive-electrode-connection contactor 9, and the negative-electrode-connection contactor 10, are configured as a module. For the same reason, this configuration makes it even easier to manufacture the battery pack 1.

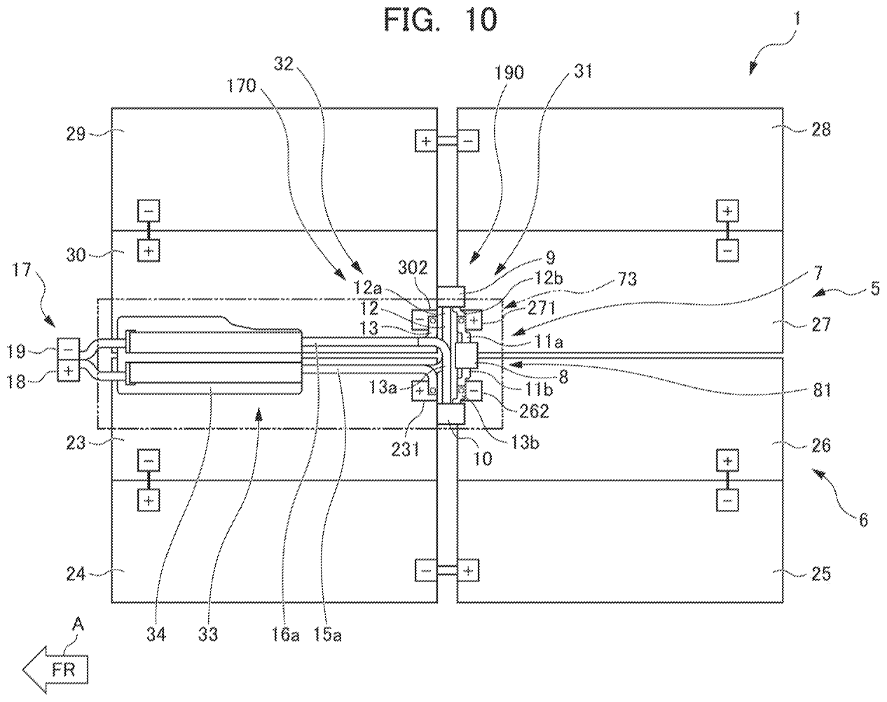

FIG. 10 is a diagram showing another modification example of the layout of the circuit elements in the battery pack 1 described with reference to FIGS. 1 to 4.

The example shown in FIG. 10 is equivalent to that in FIG. 3 in terms of electrical circuitry. Therefore, elements corresponding to those in FIG. 3 are labeled with the same reference numerals, and description thereof is omitted by utilizing the description given above with reference to FIGS. 1 to 4.

In the example shown in FIG. 10, the series-connection contactor 8, the positive-electrode-connection contactor 9, and the negative-electrode-connection contactor 10 forming the connection switcher 7, and the bus bar 11a, the bus bar 11b, the bus bar 12a, and the bus bar 13a, and the junction board 34 are configured as a single contactor-bus bar module 73.

The configuration of the example shown in FIG. 10 produces the advantageous effects in the example described with reference to FIGS. 1 to 4. Additionally, this configuration makes it easy to concentrate and compactly arrange the conductors and the switching elements, which switch the first and second module blocks 5 and 6 between a series connection and a parallel connection, at an inner side of an area where the module blocks (first and second module blocks 5 and 6) are disposed in the battery pack 1 in a top view of this area, because the junction board 34 and the circuit elements in and around the connection switcher 7 including all the switching elements of the connection switcher 7, i.e., the series-connection contactor 8, the positive-electrode-connection contactor 9, and the negative-electrode-connection contactor 10, are configured as the contactor-bus bar module 73. For the same reason, this configuration makes it even easier to manufacture the battery pack 1.

The battery pack 1 according to the present disclosure produces the following effects.

In the battery pack described in (1), the series-connection switching element, which is a circuit element of the connection switching circuit, is provided at a midpoint in the series connection between the first and second module blocks, and located at an inner side of an area where the module blocks (first and second module blocks 5 and 6) are disposed in the battery pack in a top view of this area. Furthermore, the terminals of the modules in the first and second module blocks are connected to the connection switching circuit and located close to the connection switching circuit.

Because of this configuration, conductors and the switching elements, which switch the first and second module blocks between a series connection and a parallel connection, are concentrated and compactly arranged at the inner side of the area where the module blocks (first and second module blocks 5 and 6) are disposed in the battery pack 1 in a top view of this area, allowing for a reduction in circuit size of the battery pack as a whole.

The configuration of the battery pack 1 described in (2) allows the series-connection contactor 8, the positive-electrode-connection contactor 9, and the negative-electrode-connection contactor 10 that are necessary for the connection switching circuit 81, which is a switching circuit, to be gathered in close proximity to one another, allowing for a reduction in size of the connection switching circuit 81.

This configuration also allows for a reduction in circuit size of the battery pack 1 including the connection switching circuit 81 as a whole, because the positive-electrode-connection contactor 9 and the negative-electrode-connection contactor 10 of the connection switching circuit 81, and the positive terminal 231 and the negative terminal 302, which are the total-power-output terminals 170, are in close proximity.

A smaller circuit size allows for greater flexibility in the layout of the battery pack 1 and an area around the battery pack 1.

This configuration also allows the circuit configuration to be less complex, achieving a reduction in length of conductors such as bus bars and simplified routing of the circuit conductors.

The configuration of the battery pack 1 described in (3) allows for compact connection of the conductors to the junction board 34 compared to a configuration in which the positive terminal 231 and the negative terminal 302, which are the total-power-output terminals 170, are distant from each other.

The configuration of the battery pack 1 described in (4) allows for a reduction in length of conductors that connect the positive terminal 271, which is the switching terminal of the fifth module 27 in the first module block 5, and the negative terminal 262, which is the switching terminal of the fourth module 26 in the second module block 6, and the series-connection contactor 8, because the switching terminal 271, the switching terminal 262, and the series-connection contactor 8 are in close proximity to one another.

The configuration of the battery pack 1 described in (5) allows for a reduction in length of conductors that connect the parallel-connection contactors 190, the total-power-output terminals 170, and the switching terminals 32, because the parallel-connection contactors 190, the total-power-output terminals 170, and the switching terminals 32 are in close proximity to one another.

The configuration of the battery pack 1 described in (6) makes it easy to concentrate and compactly arrange the bus bars 11a and 11b and the series-connection contactor 8, which switch the first and second module blocks 5 and 6 between a series connection and a parallel connection, at an inner side of an area where the module blocks (first and second module blocks 5 and 6) are disposed in the battery pack 1 in a top view of this area, because some of the circuit elements in and around the connection switcher 7 are configured as a module. For the same reason, this configuration makes it easier to manufacture the battery pack 1.

The configuration of the battery pack 1 described in (7) makes it easy to concentrate and compactly arrange the conductors and the switching elements, which switch the first and second module blocks 5 and 6 between a series connection and a parallel connection, at an inner side of an area where the module blocks (first and second module blocks 5 and 6) are disposed in the battery pack 1 in a top view of this area, because the circuit elements in and around the connection switcher 7 including all the switching elements, i.e., the series-connection contactor 8, the positive-electrode-connection contactor 9, and the negative-electrode-connection contactor 10, of the connection switcher 7 are configured as the contactor module 72. For the same reason, this configuration makes it much easier to manufacture the battery pack 1.

The configuration of the battery pack 1 described in (8) makes it easy to concentrate and compactly arrange the conductors and the switching elements, which switch the first and second module blocks 5 and 6 between a series connection and a parallel connection, at an inner side of an area where the module blocks (first and second module blocks 5 and 6) are disposed in the battery pack 1 in a top view of this area, because the junction board 34 and the circuit elements in and around the connection switcher 7 including all the switching elements of the connection switcher 7, i.e., the series-connection contactor 8, the positive-electrode-connection contactor 9, and the negative-electrode-connection contactor 10 are configured as the contactor-bus bar module 73. For the same reason, this configuration makes it even easier to manufacture the battery pack 1.

Although a battery pack according to the present disclosure has been described above, the present invention is not limited thereto.

Appropriate changes may be made to the detailed configuration without departing from the scope of the present invention.

For example, the first and second module blocks may both have a configuration in which groups each including a predetermined number of modules connected in series are connected in parallel, instead of the configuration described above in which four modules are connected in series.

Alternatively, the first and second module blocks may both have a configuration including two modules.

### EXPLANATION OF REFERENCE NUMERALS

1: Battery pack
2: Cell
3: Module
4: Module block
5: First module block
6: Second module block
7: Connection switcher
8: Series-connection contactor (series-connection switching element)
9: Positive-electrode-connection contactor (parallel-connection switching element)
10: Negative-electrode-connection contactor (parallel-connection switching element)
11, 12, 13: Conductor
11a, 12a, 13a: Bus bar
15: Positive-electrode output conductor
15a: Bus bar
16: Negative-electrode output conductor
16a: Bus bar
17: Total-power-output external terminal
18: Positive-electrode total-power-output external terminal
19: Negative-electrode total-power-output external terminal
20: Positive-electrode output contactor
21: Negative-electrode output contactor
22: Pre-charge contactor
23: First module
24: Second module
25: Third module
26: Fourth module
27: Fifth module
28: Sixth module
29: Seventh module
30: Eighth module
31: Switching-side module group
32: Switching terminal
33: Total-power-output-side module group
34: Junction board
71, 72: Contactor module
73: contactor-bus bar module
81: Connection switching circuit
170: Total-power-output terminal
190: Parallel-connection contactor
231: Positive terminal (total-power-output positive terminal)
262: Negative terminal
271: Positive terminal
302: Negative terminal (total-power-output negative terminal)

What is claimed is:

1. A battery pack comprising:
a first module block and a second module block arranged side-by-side, the first and second module blocks being separate module blocks each including a plurality of modules electrically connected to one another, the plurality of modules each including a plurality of cells electrically connected to one another; and
a connection switching circuit including a series-connection switching element and a parallel-connection switching element configured to selectively switch connection between the first and second module blocks between a series connection and a parallel connection, wherein
in the connection switching circuit, the series-connection switching element is provided at a midpoint in the series connection and located at an inner side of an area where the module blocks are disposed in the battery pack in a top view of this area, and
terminals of the modules in the first and second module blocks are connected to the connection switching circuit and located close to the connection switching circuit.

2. The battery pack according to claim 1, wherein
the first and second module blocks include a switching-side module group, which is a group of modules each having a terminal serving as a switching terminal connected to the connection switching circuit among the plurality of modules, and a total-power-output-side module group, which is a group of modules each having a terminal serving as a total-power-output terminal to which a total power outputted from the first and second module blocks is directed among the plurality of modules,
the switching terminals are located in respective module end sections closer to the total-power-output-side module group in the modules belonging to the switching-side module group, and
the total-power-output terminals are located in respective module end sections closer to the switching-side module group in the modules belonging to the total-power-output-side module group.

3. The battery pack according to claim 2, wherein
the total-power-output terminals are electrically connected to a junction board for the battery pack, and
the total-power-output terminals in the first and second module blocks are respectively provided in module end sections at neighboring sides of the mutually neighboring modules belonging to the total-power-output-side module group.

4. The battery pack according to claim 2, wherein
the connection switching circuit includes a series-connection contactor as the series-connection switching element,
the switching terminals are respectively provided in module end sections at neighboring sides of the mutually neighboring modules belonging to the switching-side module group,
the series-connection contactor is disposed between the switching terminal in the first module block and the switching terminal in the second module block, and
the series-connection contactor is electrically connected to each of the switching terminals.

5. The battery pack according to claim 2, comprising, as the parallel-connection switching element, a plurality of parallel-connection contactors disposed between the switching terminals and the total-power-output terminals, and electrically connected to the total-power-output terminals and the switching terminals.

6. The battery pack according to claim 1, wherein
the series-connection switching element, a conductor connecting the series-connection switching element and the first module block, and a conductor connecting the series-connection switching element and the second module block are configured as a single module.

7. The battery pack according to claim 1, comprising two parallel-connection switching elements as the parallel-connection switching element, wherein
the series-connection switching element, the two parallel-connection switching elements, a conductor connecting the series-connection switching element and the first module block, a conductor connecting the series-connection switching element and the second module block, a conductor connecting one of the parallel-connection switching elements and the first module block, and a conductor connecting the other parallel-connection switching element and the second module block are configured as a single module.

8. The battery pack according to claim 1, comprising two parallel-connection switching elements as the parallel-connection switching element, wherein
the series-connection switching element, the two parallel-connection switching elements, a conductor connecting the series-connection switching element and the first module block, a conductor connecting the series-connection switching element and the second module block, a conductor connecting one of the parallel-connection switching elements and the first module block, a conductor connecting the other parallel-connection switching element and the second module block, and a junction board located on adjacent portions of the first and second module blocks are configured as a single contactor-bus bar module.
